(19) United States
(12) Patent Application Publication
(10) Pub. No.: US 2003/0091875 A1
(43) Pub. Date: May 15, 2003

(54) Method for cold starting fuel cells of a fuel cell facility, and corresponding fuel cell facility

(76) Inventors: Ulrich Gebhardt, Langensendelbach (DE); Konrad Mund, Uttenreuth (DE); Manfred Waidhas, Nurnberg (DE)

Correspondence Address: LERNER AND GREENBERG, P.A., Post Office Box 2480, Hollywood, FL, 33022-2480, US

(21) Appl. No.: 10/292,332

(22) Filed: Nov. 12, 2002

Related U.S. Application Data
(63) Continuation of application No. PCT/DE01/01790, filed on May 10, 2001.

(30) Foreign Application Priority Data
May 11, 2000 (DE) 100 23 036.9

(51) Int. Cl. H01M 8/00; H01M 8/04

(52) U.S. Cl. 429/13; 429/26

(57) ABSTRACT

Cold starting includes the steps of directly converting process gas into thermal energy by a catalytic reaction, and utilizing the thermal energy to heat up the fuel cell stack, wherein the process of heating up the fuel cell stack is carried out separately from the operation of the fuel cell facility. Heating elements form separate components in the fuel cell stack, the element being mounted in a predetermined order in the fuel cell stack.

### CROSS-REFERENCE TO RELATED APPLICATION

This application is a continuation of copending International Application No. PCT/DE01/01790, filed May 10, 2001, which designated the United States and was not published in English.

### BACKGROUND OF THE INVENTION

Field of the Invention

The invention relates to a method for cold starting fuel cells of a fuel cell facility, in which individual fuel cells form at least one fuel cell stack. In addition, the invention also relates to a fuel cell facility with the associated measures for carrying out the described method.

A fuel cell facility has one electrolyte per fuel cell unit, for example, an ion exchange membrane in the case of the PEM fuel cell. In membrane fuel cells, this ion exchange membrane is proton-conducting, the proton conductivity in membranes based on sulfonated compounds being ensured by liquid water in the membrane. On the other hand, in membrane types or dies that are impregnated with phosphoric acid, the proton conductivity is provided by the phosphoric acid.

The above-mentioned types of fuel cell have the drawback that, at low temperatures, the electrolyte crystallizes, i.e., water crystallizes at below 0° C. or phosphoric acid crystallizes at below 42° C. The membrane resistance suddenly increases by at least two to three powers of ten. Autothermal heating of the fuel cells is, then, no longer possible without additional measures.

To avoid the latter problem, it has already been proposed for the fuel cell stack to be continuously operated at a minimal load so that the temperature in the individual fuel cells does not drop below the corresponding crystallization temperature. To avoid such a temperature drop, it is also possible for the cell stack to be started for a brief time in each case just before the crystallization point, i.e., the freezing point of the membrane liquid, is reached.

The prior art concepts have the drawback that fuel is still being used to compensate for the heat loss even when power is not required. Particularly when an additional reformer is being used, intermittent operation is not readily possible because the reformer also has to be brought to operating temperature in parallel with the fuel cell facility. European Patent Application EP 0 924 163 A2, corresponding to U.S. Pat. No. 6,268,075 to Autenreith et al., specifically discloses a method for operating fuel cells that works in combination with the steam reforming, a heating operation, in which, in a first operating phase, at least the evaporator and the reforming reactor are heated by the catalytic burner device and, in a second operating phase, a hydrocarbon/steam mixture with a hydrocarbon/steam ratio that is higher than in standard operation is provided in the evaporator and fed to the reactor, being carried out during a cold start of the facility. The mixture of substances that emerges from the reactor is fed to a catalytic burner device through the membrane module.

The older document German Published, Non-Prosecuted Patent Application DE 199 10 387 A1, corresponding to U.S. Patent Publication No. 2002/071,972 to Gebhardt et al., which is not a prior publication, proposes a method for cold starting a fuel cell facility in which the waste heat from the combustion of the primary and/or secondary fuel is utilized to heat the fuel cell stack. In such a case, a line is provided between the heating configuration and the fuel cell stack so that the heat from the heating configuration can be released to the stack.

The further prior art methods for autothermal heating-up of fuel cells are usually based on short-circuit operation thereof. However, these methods are limited by the resistance of the electrolyte.

### SUMMARY OF THE INVENTION

It is accordingly an object of the invention to provide a method for cold starting fuel cells of a fuel cell facility, and corresponding fuel cell facility that overcome the hereinafore-mentioned disadvantages of the heretofore-known devices and methods of this general type and that improves the cold starting of fuel cells, in particular, of a polymer membrane fuel cell, at ambient temperatures that lie below the freezing point.

With the foregoing and other objects in view, there is provided, in accordance with the invention, method for cold starting fuel cells of a fuel cell facility, including the steps of forming at least one fuel cell stack with individual fuel cells, directly converting process gas into thermal energy in a catalytic reaction at a catalyst, and utilizing thermal energy to heat the at least one fuel cell stack, the process of heating the at least one fuel cell stack taking place separately from operation of the fuel cell facility.

With the objects of the invention in view, there is also provided a fuel cell facility, including at least one fuel cell stack having individual fuel cells, and catalytic heating units having a catalyst, the heating units associated with the at least one fuel cell stack for cold starting the fuel cells, forming separate components disposed in a predetermined sequence in the at least one fuel cell stack, and directly converting process gas into thermal energy in a catalytic reaction at the catalyst and heating the at least one fuel cell stack with the thermal energy in a process separate from operation of the fuel cell facility.

The invention, therefore, solves the problem that is being discussed by catalytic heating that is integrated directly in the fuel cell stack. For such a purpose, there may, preferably, be elements that form heating cells. Unlike in the prior art, these heating cells are now separate components that may be disposed downstream of each cell or downstream of every n-th cell (where n=2 to 10). In such components the fuel gas is directly converted at a suitable catalyst and the heat that is released is utilized virtually without losses to heat the fuel cell stack. Unlike in Gebhardt et al., in the method according to the invention, the processes involved in operation of the fuel cell and in heating-up are separated, which enables the individual components to be constructed effectively.

An advantage of the invention is that the catalytic reaction can be optimized in terms of surface area by using a concentration gradient in the catalyst density of the heating element. As a result, the heat that is liberated is optimally utilized and undesirable heat losses are minimized. It is, advantageously, also possible to provide a porous, structured distributor layer, with the result that local overheating of an individual fuel cell, which could lead to damage to the fuel cell, is avoided.

The invention also results in the possibility of integrating the fuel cells directly in the cooling circuit that is usually present. Such a configuration, in addition to the direct heat transfer, advantageously, also results in uniform distribution of the heat through the stack or through defined segments of the cell stack by the cooling circuit.

The overall result of the invention is that the heat transfer does not require an additional liquid circuit and/or heat exchanger for transferring heat from external heat sources to the fuel cell.

In accordance with another mode of the invention, the catalytic reaction is optimized by forming a concentration gradient in a catalyst density in a heating cell.

In accordance with a further mode of the invention, heat generated by the heating cell is uniformly distributed with the cooling circuit through the fuel cell stack or through defined segments of the fuel cell stack.

In accordance with an added mode of the invention, heat generated by the catalytic combustion is used in the heating cell without losses to heat the fuel cell stack.

In accordance with an additional mode of the invention, heat generated by the catalytic combustion is used in the heating cell substantially without losses to heat the fuel cell stack.

In accordance with yet another feature of the invention, the heating units are disposed downstream of each of the cells of the fuel cell stack with respect to a flow direction of the process gas.

In accordance with yet a further feature of the invention, the heating units are disposed downstream of every n-th cell in the fuel cell stack with respect to a flow direction of the process gas.

In accordance with yet an added feature of the invention, the heating units are disposed downstream of every n-th cell in the fuel cell stack with respect to a flow direction of the process gas, where n=2 to 10.

In accordance with yet an additional feature of the invention, the heating units have a porous, structured distributor layer.

In accordance with again another feature of the invention, at least one of the heating units has a porous, structured distributor layer.

In accordance with again a further feature of the invention, there are provided cooling circuit components, the heating units and the cooling circuit being integrated in a common component.

In accordance with again an added feature of the invention, there is provided a common cooling circuit, the heating units being integrated in the common cooling circuit.

In accordance with again an additional feature of the invention, there is provided a common cooling/heating circuit connected to each of the cells in the fuel cell stack, the heating units being integrated in the common cooling/heating circuit.

In accordance with still another feature of the invention, each of the heating units has a central distribution passage and a catalyst density with a concentration gradient dc/dl, where c is a concentration of material of the catalyst, and l is a distance from the central distribution passage.

In accordance with a concomitant feature of the invention, at least one of the heating units has a central distribution passage and a catalyst density with a concentration gradient dc/dl, where c is a concentration of material of the catalyst and l is a distance from the central distribution passage.

Other features that are considered as characteristic for the invention are set forth in the appended claims.

Although the invention is illustrated and described herein as embodied in a method for cold starting fuel cells of a fuel cell facility and corresponding fuel cell facility, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, cross-sectional view of a first configuration of separate heating and cooling units in a fuel cell stack according to the invention;

FIG. 2 is a fragmentary, cross-sectional view of a heating element of FIG. 1;

FIG. 3 is a fragmentary, cross-sectional view of an alternative embodiment of the fuel cell stack of FIG. 1 with combined heating/cooling elements;

FIG. 4 is a fragmentary, cross-sectional view of a heating/cooling element of FIG. 3; and

FIG. 5 is a fragmentary, plan view of a heating region of the heating element of FIGS. 2 or 4.

### DESCRIPTION OF THE PREFERRED EMBODIMENTS

In the figures of the drawings, unless stated otherwise, identical reference symbols denote identical parts. The figures are, in part, described jointly.

In the devices described below, as part of a fuel cell facility with in each case at least one fuel cell stack, the heating and the electrochemical operation by heating cells integrated in the fuel cell stack is to be separated. The result of this is that the heat from the catalytic combustion can be utilized without losses to heat the fuel cell facility.

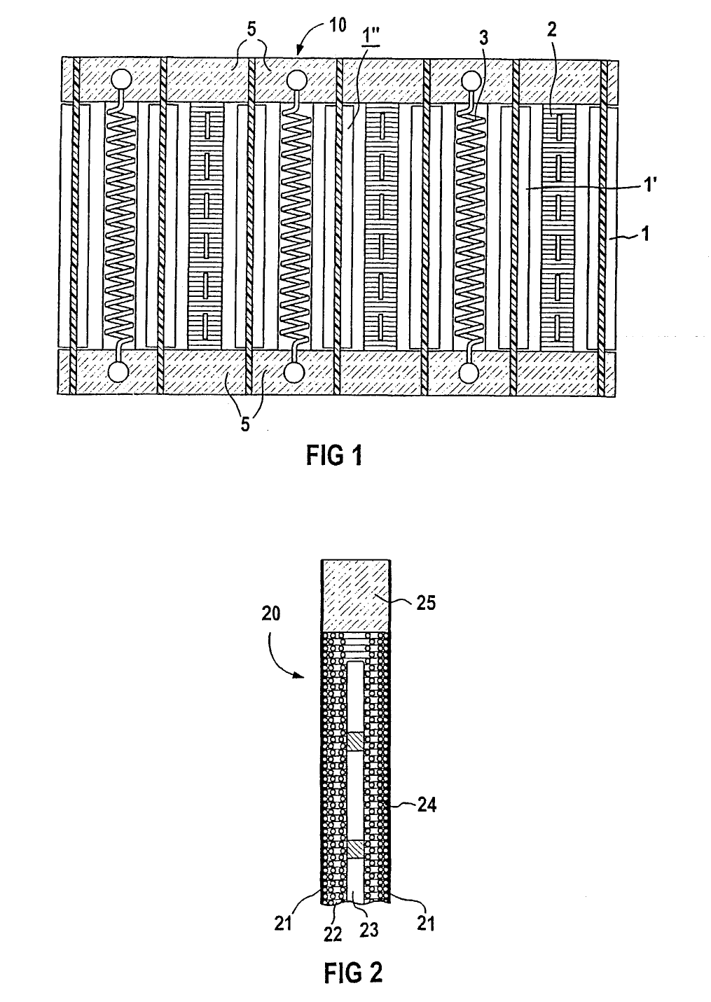

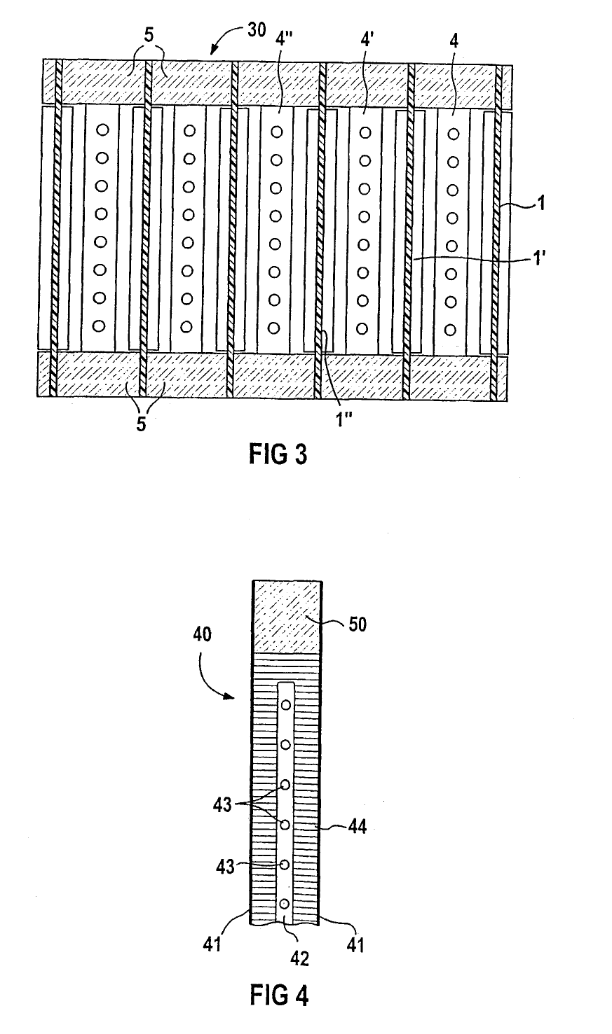

Referring now to the figures of the drawings in detail and first, particularly to FIGS. 1 and 3 thereof, there is shown a fuel cell stack 10 or 30, respectively, of a fuel cell facility. Such stacks include, for example, up to 100 individual fuel cells; fuel cell facilities that satisfy practical requirements may have a plurality of stacks with common peripherals.

In FIG. 1, such a fuel cell stack 10 includes individual membrane electrode assemblies (MEAs) 1, 1′, . . . with in each case adjacent, alternately disposed heating units 2, 2′, . . . and cooling units 3, 3′, . . . , each MEA 1, by way of example, being adjoined by one heating unit 2 and one cooling unit 3, which are closed off at the side by seals 5. This means that between individual membrane electrode assemblies 1, 1′, . . . heating units 2, 2′ for selective heating and cooling units 3, 3′ for cooling of the fuel cell stack are disposed alternately. The heating units 2, 2′, . . . have a gas distribution layer and a catalyst, as will be explained in more detail below.

In the configuration shown in FIG. 1, therefore, after every second membrane electrode assembly 1, 1′, . . . there is a separate element 2 as heating cell alternating with a cooling unit 3. Configurations with other sequences of heating elements and cooling units may also be useful; by way of example, there may be heating units after every n-th cell of the fuel cell stack 10, where n possibly being between 2 and 10.

FIG. 2 illustrates a single heating cell 20, which is used for the fuel cell stack 10 in FIG. 1 and operates in accordance with the catalytic combustion process, as an individual component.

In detail, the heating cell 20 includes two bipolar plates 21, which enclose a porous, electrically conductive layer 22 as gas distribution layer. In the center of the heating cell 20, running parallel to the bipolar electrodes 21 there is a gas distribution passage 23, into which fuel gas can flow and from which fuel gas is distributed laterally in the porous layer 22, which contains catalyst material. The catalyst material 24 is concentrated at the edge upstream of the bipolar plates and is indicated by dots. Under the influence of the catalyst, an exothermic reaction takes place in the fuel gas, releasing heat. The heat that has been released by the catalytic combustion process is transferred without losses to the fuel cell stack 10 and is used to heat the latter during cold starting of the fuel cell facility.

FIG. 3 shows a fuel cell stack 30 that includes combined cooling/heating units 4, 4′, . . . In practice, this means that the heating cell is integrated in the existing cooling circuit. As a result, the cooling and heating elements, which are otherwise separate, are combined, a cooling/heating unit 4, 4′, . . . of this type expediently being present downstream of each fuel cell unit.

In each cooling/heating unit 4 there are, in the transverse direction, gas distribution passages that are provided with catalyst material and are described in more detail below.

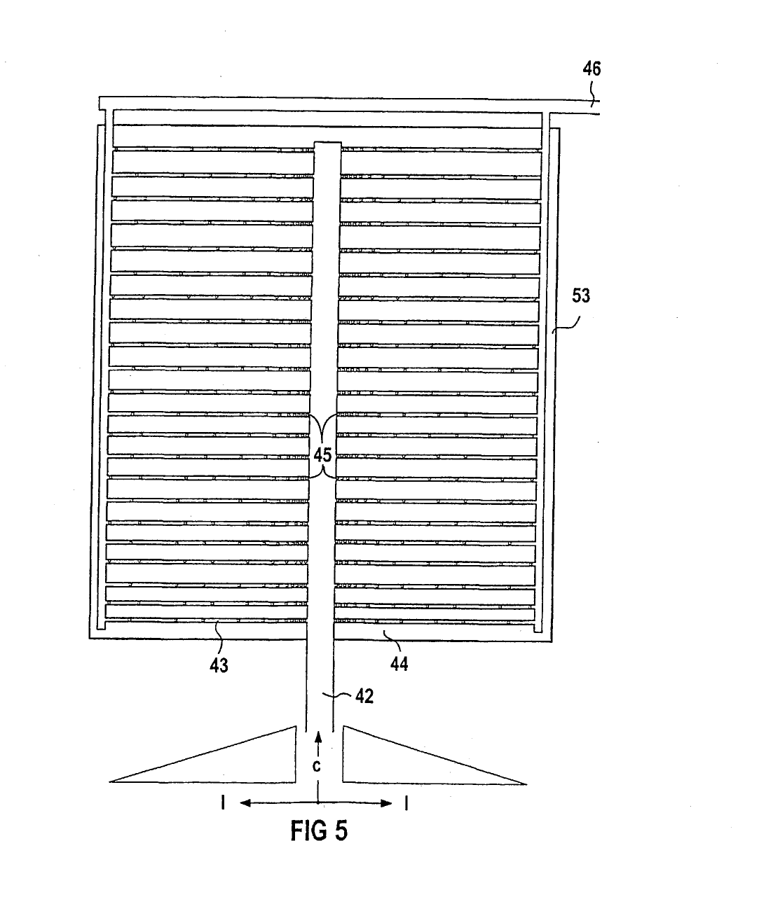

A combined cooling/heating element from FIG. 3 is illustrated in FIG. 4 as an individual component 40. There are two bipolar plates 41, which enclose a cooling/heating medium 44. A gas supply and distribution passage 42, from which individual gas passages 43, which are spaced apart in the transverse direction and have catalyst material 45 distributed over the surface, lead off, runs longitudinally in the component 40. The catalyst material 45 can be seen from FIG. 5, where it is indicated as material concentration points 45.

The components 20 and 40 in FIGS. 2 and 4 are each closed off by seals 25 and 50.

FIG. 5 illustrates the plan view of a component for heating. It can be seen that the gas admission passage 42 branches into the parallel distribution passages 43 and that there is a common outlet passage 46. As a result, the entire surface 53 of the cooling/heating element 40 is covered with the cooling/heating medium 44 from the distribution passages 43.

It should be noted that catalyst material 45 is introduced into the gas distribution passages 43 over the entire surface 53.

As can be seen in FIG. 5 from the dots illustrating the catalyst material 45 in the figure and, in particular, from the associated graph at the bottom of FIG. 5, there is a gradient in the concentration c of the catalyst material 45, i.e., the concentration c of the catalyst material 45 is higher in the vicinity of the gas admission passage 42 than in the vicinity of the outlet passage 46. The concentration c of the catalyst material 45 may, in particular, decrease in linear fashion over the distance 1. Other dependent relationships are also possible.

In other configurations, there may be radially running gas distribution passages, which correspondingly involve radial concentration gradients of the catalyst material 45. In any event, the result is that the reaction of the fuel gas proceeds from the inside outward over the surface area.

In the configurations described, the process of recombining hydrogen and air is utilized to generate heat. The advantageous result is that the heat is produced uniformly during the catalytic combustion. It is, therefore, possible to utilize the heat as far as possible without losses to heat fuel cell stacks and to improve their cold-starting performance.

We claim:

1. A method for cold starting fuel cells of a fuel cell facility, which comprises:
forming at least one fuel cell stack with individual fuel cells;
directly converting process gas into thermal energy in a catalytic reaction at a catalyst; and
utilizing thermal energy to heat the at least one fuel cell stack, the process of heating the at least one fuel cell stack taking place separately from operation of the fuel cell facility.

2. The method according to claim 1, which further comprises optimizing the catalytic reaction by forming a concentration gradient in a catalyst density in a heating cell.

3. The method according to claim 1, which further comprises uniformly distributing heat generated by the heating cell with the cooling circuit one of through the fuel cell stack and through defined segments of the fuel cell stack.

4. The method according to claim 1, which comprises utilizing heat generated by the catalytic combustion in the heating cell without losses to heat the fuel cell stack.

5. The method according to claim 1, which comprises utilizing heat generated by the catalytic combustion in the heating cell substantially without losses to heat the fuel cell stack.

6. A fuel cell facility, comprising:
at least one fuel cell stack having individual fuel cells; and
catalytic heating units having a catalyst, said heating units:
associated with said at least one fuel cell stack for cold starting said fuel cells;
forming separate components disposed in a predetermined sequence in said at least one fuel cell stack; and
directly converting process gas into thermal energy in a catalytic reaction at said catalyst and heating said at least one fuel cell stack with the thermal energy in a process separate from operation of the fuel cell facility.

7. The fuel cell facility according to claim 6, wherein said heating units are disposed downstream of each of said cells of said fuel cell stack with respect to a flow direction of the process gas.

8. The fuel cell facility according to claim 6, wherein said heating units are disposed downstream of every n-th cell in said fuel cell stack with respect to a flow direction of the process gas.

9. The fuel cell facility according to claim 6, wherein said heating units are disposed downstream of every n-th cell in said fuel cell stack with respect to a flow direction of the process gas, where n=2 to 10.

10. The fuel cell facility according to claim 6, wherein said heating units have a porous, structured distributor layer.

11. The fuel cell facility according to claim 6, wherein at least one of said heating units has a porous, structured distributor layer.

12. The fuel cell facility according to claim 6, including cooling circuit components, said heating units and said cooling circuit being integrated in a common component.

13. The fuel cell facility according to claim 6, including a common cooling circuit, said heating units being integrated in said common cooling circuit.

14. The fuel cell facility according to claim 6, including a common cooling/heating circuit connected to each of said cells in said fuel cell stack, said heating units being integrated in said common cooling/heating circuit.

15. The fuel cell facility according to claim 6, wherein each of said heating units has:
a central distribution passage; and
a catalyst density with a concentration gradient dc/dl, where:
c is a concentration of material of said catalyst; and
l is a distance from said central distribution passage.

16. The fuel cell facility according to claim 6, wherein at least one of said heating units has:
a central distribution passage; and
a catalyst density with a concentration gradient dc/dl, where:
c is a concentration of material of said catalyst; and
l is a distance from said central distribution passage.
